(19) United States
(12) Patent Application Publication
(10) Pub. No.: US 2002/0083190 A1
(43) Pub. Date: Jun. 27, 2002

(54) Apparatus and method for GFP frame transfer

(76) Inventors: Satoshi Kamiya, Tokyo (JP); Motoo Nishihara, Tokyo (JP)

Correspondence Address: McGinn & Gibb, PLLC, Suite 200, 8321 Old Courthouse Road, Vienna, VA, 22182-3817, US

(21) Appl. No.: 10/024,144

(22) Filed: Dec. 21, 2001

(30) Foreign Application Priority Data
Dec. 26, 2000 (JP) 396184/2000

(51) Int. Cl. G06F 15/16

(52) U.S. Cl. 709/236

(57) ABSTRACT

The GFP frame transfer apparatus according to the present invention includes a GFP path frame formation unit (7, 8, 11, 13) that stores a label corresponding to a path ID defined to uniquely specify a path from the Ingress node to Egress node within a GFP network in a predetermined field of the extension header area of the GFP frame, stores packets to be transferred through the path in the payload field of the GFP frame and forms a GFP path frame.

### BACKGROUND OF THE INVENTION

1. Field of the Invention

The present invention relates to a GFP (Generic Frame Procedure) frame transfer apparatus and GFP frame transfer method for transferring GFP frames, and more particularly, to a GFP frame transfer apparatus and GFP frame transfer method capable of expanding the usability of GFP by allowing flexible routing of GFP frames, reduction of overhead and accommodation of a wide range of applications, etc.

2. Description of the Prior Art

With the rapid spread of the Internet, traffic of data systems such as IP (Internet Protocol) packets is expanding drastically in recent years. Realizing an efficient transfer of a data system traffic requires a network configuration and equipment designed in conformance with a conventional voice network such as a telephone network to be changed to a mode suitable for transferring data system traffic, above all, a mode suitable for transferring variable-length packets.

Conventionally, there is SONET/SDH (Synchronous Optical NETwork/Synchronous Digital Hierarchy) as a digital network for WAN (Wide Area Network). The SONET/SDH adopts a data structure suitable for accommodating voice signals. With the expansion of data system traffic in recent years, technologies for efficient transfers of data system traffic on the SONET/SDH are under study.

One of such technologies is GFP (Generic Frame Procedure). This GFP is a general-purpose encapsulation technology or adaptation technology to accommodate variable-length packets with various protocols in an OTN (Optical Transport Network) using WDM (Wavelength Division Multiplexing) in addition to SONET/SDH. The technical content of the GFP is disclosed in a document “T1X1.5/2000-209 “Generic Framing Procedure (GFP) Specification” (hereinafter referred to as “document (1)”), by T1X1.5, one of the technical committees of the U.S.A. T1 Committee.

FIG. 1 shows a protocol stack of the GFP. As shown, the GFP consists of a GFP payload dependent sub-layer and a GFP payload independent sub-layer. GFP is a technology for accommodating various user protocols (subscriber network protocols: Ethernet, HDLC, Token Ring, etc.) at edge nodes that interface with this subscriber network and transferring these user protocols transparently.

FIG. 2 shows a basic frame format of the GFP. The GFP frame shown in FIG. 2 consists of a 4-byte core header field, a variable-length (4 to 65535 bytes) payload area field and a 4-byte FCS (Frame Check Sequencer) field.

As shown in FIG. 3, the above-described core header includes two PLI (PDU Length Indicator) fields each having two bytes and two cHECs (core Header Error Control) fields. The PLI indicates the length (number of bytes) of the above-described payload area and the CHEC indicates the result of a CRC16 calculation carried out on the PLI field and is used for protecting integrity of the information in the core header.

As shown in FIG. 4, the payload area consists of a payload header and payload field (hereinafter simply referred to as “payload”). The payload header has a variable length of 4 to 64 bytes. The payload has a variable length of 0 to 65535 bytes. The payload in this payload area stores information to be transferred.

The FCS field is a 4-byte fixed length field shown in FIG. 5. The FCS field indicates the result of an FCS calculation (a kind of CRC32 calculation) conducted on the whole of payload area and used to protect the content of the payload area.

FIG. 6 illustrates the payload header in a GFP point-to-point frame (linear frame) (GFP frame used in a point-to-point connection (connection between two nodes)). The payload header of the linear frame has Type fields, tHEC (type Header Error Control) fields, DP (Destination Port), SP (Source Port) as extension headers and eHEC (extension Header Error Control) fields. The Type field indicates the type of a GFP frame format and the type of protocol of a higher layer of data stored in the payload field. The tHEC indicates the result of a CRC16 calculation on the Type field and is used to protect integrity of information in the Type field. The DP (destination port number) indicates one of 16 ports owned by the GFP edge node on the Egress side and indicates the output destination from the GFP edge node on the Egress side of a user packet stored in the relevant GFP frame. The SP (source port number) indicates one of 16 ports owned by the GFP edge node on the Ingress side and indicates the output destination from the GFP edge node on the Egress side of a user packet stored in the relevant GFP frame. The eHEC indicates the result of a CRC16 calculation carried out on the above-described extension header (Type and tHEC are not included) and is used to protect integrity of information in the extension header.

FIG. 7 illustrates the payload header in a GFP ring frame (GFP frame used in a ring connection). The payload header in the ring frame includes Type fields, tHEC fields, a DP field, an SP field and eHEC fields as in the case of the payload header of the linear frame in FIG. 6. The payload header in the ring frame includes in its extension header (octet #5 to #20 in FIG. 7), DE (Discard Eligibility) as a Priority field and COS (Class Of Service), TTL (Time To Live) field, destination MAC (Destination Media Access Control) address (DSTMAC) and source MAC (Source Media Access Control) address (SRC MAC). The DE indicates priority in discarding the GFP frame. The specific method of use of COS (Class Of Service) is under study. The TTL is an 8-bit area indicating the remaining count of GFP transfers (GFP hops) and, for example, TTL=0 indicates that the GFP frame is terminated at the next GFP node. The destination MAC address is a 6-byte field indicating the address of the destination GFP node and the source MAC address is a 6-byte field indicating the address of the source GFP node.

In the GFP, the type of adaptation is specified by the Type field in the payload header. In the GFP, it is also possible to define information according to individual adaptations in the payload header. Adaptations assuming a point-to-point frame and ring frame are currently proposed as shown above and these adaptations include features as shown below.

Point-to-point frame . . . Multiplexes streams of a plurality of user protocols at the SONET node of Ingress and transfers it to the SONET node of Egress. To identify the multiplexing of streams, port addresses (SP, DP) are provided in the payload header. Since no address information to identify the SONET nodes exists in the payload header, at the relay node routing cannot be performed in GFP frame units.

Ring frame . . . Constructs a ring similar to a shared bus on the topology of the SONET ring and provides the client with an Ethernet-like packet transfer. To provide a transfer within the ring, MAC addresses to identify SONET nodes are provided in the payload header.

The adaptation method for accommodating Gigabit Ethernet, ESCON, Fiber Channel, FICON, etc. in the above-described GFP is reported in the above document (1) and document: “T1X1.5/2000-210, A Proposed Format for the GFP Type Field, Oct. 2000” (hereinafter referred to as “document (2)”) and document “T1X1.5/2000-197, Transparent GFP Mappings For Fiber Channel and ESCON, Oct. 2000” (hereinafter referred to as “document (3)”).

However, network models considered in these documents are limited only to the above-described point-to-point connections or ring connections. However, when consideration is given to ultimate purposes of a GFP described in document “T1X1.5/2000-127R1, Report of the Breakout Group on Data over SONET, Oct. 2000” (hereinafter referred to as “document (4)”), it is necessary to transfer user traffic by multiplexing different pieces of user data on a variety of network topologies without causing net expansion.

In realizing flexible transfers on a variety of network topologies as shown in the above-described document (4), the existing adaptation involves several problems. The criteria that should be met by new adaptation include the following:

Overhead . . . User data should be encapsulated into a GFP frame to prevent net expansion. It is particularly important to reduce overhead of the payload header.

Multiplexing . . . Multiplexing a plurality of user streams and transferring the multiplexed stream requires a mechanism capable of identifying individual user streams.

Routing . . . Realizing flexible transfers on a network topology requires a GFP frame to have address information that can be routed.

Applications on current telecommunication networks have features such as connection-oriented, logical point-to-point connection mode, switching using labels and transfers with a plurality of user streams multiplexed, etc.

Typical applications include ATM, Frame Relay, MPLS, etc. All these applications include connection-oriented end-to-end paths and carry out transfers according to labels attached to every packet and cell. As described in the document (4), the definition of such a connection-oriented path is effective when flexible transfers are carried out on a variety of topologies (inter-multi-ring connection, connections via even DCS, etc.). These transfer systems can produce statistical multiplexing effects by multiplexing a plurality of links which are at the same time basically point-to-point logical links.

Furthermore, POS (Packet Over SONET) is currently often used to transfer packet data between routers including MPLS. The POS connects routers point-to-point at CBR (Constant Bit Rate). However, users do not always use the bandwidth 100%. Thus, an application that accommodates the POS on one SONET path and allows other best effort traffic to use an extra bandwidth may be considered. The application secures QoS (Quality of Service) by assuring the bandwidth for a peak speed through priority control for POS connection users within the SONET path. Once GFP common encapsulation makes it possible to multiplex the IP (POS) and best effort traffic, the link utilization rate can be improved by a statistical multiplexing effect.

Thus, it is assumed that there will be great demand for connection-oriented and label-multiplexed traffic. However, accommodating such traffic with a frame format already specified by a GFP involves the following problems:

A point-to-point frame cannot realize flexible end-to-end transfers.

Since a point-to-point frame has no address information to identify a transfer destination SONET node, a relay node cannot perform routing in GFP frame units. User streams multiplexed at an Ingress node must be transferred up to an Egress node on an STM path. At the Egress node, individual streams are transferred to a predetermined tributary (subscriber network, etc.) based on a port address.

A ring frame produces extremely large overhead on applications other than Ethernet, causing net expansion.

As shown in FIG. 8, encapsulating a user interface through HDLC framing into a ring frame produces approximately 50% overhead, causing extremely large net expansion. Overhead is also produced in a point-to-point frame, but it remains within approximately 20%.

When many user streams are multiplexed at the ingress node, a ring frame cannot identify individual user streams.

A MAC address in a ring frame only identifies the address of a SONET node. If users are accommodated by port, user streams on the tributary side can be identified with port numbers, but its maximum number is limited to 16. Thus, if, for example, many user streams are multiplexed and transferred to the Egress node as shown in FIG. 9, the Egress node needs to terminate a layer higher than the GFP, thus causing an increase of the apparatus cost and reduction of utility of the GFP frame.

A ring frame cannot identify a path easily.

A MAC address in a ring frame only indicates the address of a source node and the address of a destination node. It is not the information that indicates the path from the source node to the destination node. In order to control a connection-oriented path on the ring frame, it is necessary to convert a pair of the source MAC address and destination MAC address to a path ID specified in the network and control the path ID. This increases the costs of the SONET node and the entire network.

The present invention is intended to solve the above-described problems. It is an object of the present invention to provide a GFP frame transfer apparatus and GFP frame transfer method capable of providing flexible and connection-oriented GFP frame transfers on even complicated network topologies other than point-to-point connections and ring connections, reducing overhead, multiplexing/separating a plurality of user streams, etc. and thereby improving usability of GFP.

### SUMMARY OF THE INVENTION

A first object of the present invention is to provide flexible connection-oriented GFP frame transfers on even complicated network topologies other than point-to-point connections and ring connections.

A second object of the present invention is to make it possible to improve usability of GFP by reducing overhead, multiplexing/separating a plurality of user streams.

The GFP frame transfer apparatus of the present invention comprises a GFP path frame formation section that stores a label corresponding to a path ID defined to uniquely specify the path from the Ingress node to Egress node within the GFP network made up of a plurality of GFP nodes in a predetermined field of the extension header area of the GFP frame, stores packets to be transferred through the path in the payload field of the GFP frame and forms a GFP path frame.

The GFP frame transfer apparatus in another configuration of the present invention comprises a GFP path frame reception section that stores a label corresponding to a path ID defined to uniquely specify the path from the Ingress node to Egress node within the GFP network made up of a plurality of GFP nodes in a predetermined field of the extension header area of the GFP frame and receives the GFP path frame that stores the packet to be transferred through the path in its payload field from the GFP network, a label switching section that identifies the output port of the GFP frame transfer apparatus corresponding to the label stored in the extension header area of the GFP path frame and switches the GFP path frame to the identified output port so that the GFP path frame is sent to the GFP network through the transmission path connected to the identified output port and a GFP path frame transmission section that transmits the GFP path frame switched by the label switching section from the identified output port to the GFP network.

The GFP frame transfer method of the present invention comprises a GFP path frame forming step of storing a label corresponding to a path ID defined to uniquely specify the path from the Ingress node to Egress node within the GFP network made up of a plurality of GFP nodes in a predetermined field of the extension header area of the GFP frame, storing packets to be transferred through the path in the payload field of the GFP frame and forming a GFP path frame.

The GFP frame transfer method in another configuration of the present invention comprises a GFP path frame receiving step of storing a label corresponding to a path ID defined to uniquely specify the path from the Ingress node to Egress node within the GFP network made up of a plurality of GFP nodes in a predetermined field of the extension header area of the GFP frame and receiving the GFP path frame that stores the packet to be transferred through the path in its payload field from the GFP network, a label switching step of identifying the output port corresponding to the label stored in the extension header area of the GFP path frame and switching the GFP path frame to the identified output port so that the GFP path frame is sent to the GFP network through the transmission path connected to the identified output port and a GFP path frame transmitting step of transmitting the GFP path frame switched in the label switching step from the identified output port to the GFP network.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 illustrates a protocol stack of a GFP;

FIG. 2 illustrates a basic frame format of the GFP;

FIG. 3 illustrates a format of a core header of the GFP frame;

FIG. 4 illustrates a format of a payload area of the GFP frame;

FIG. 5 illustrates a format of an FCS field of the GFP frame;

FIG. 6 illustrates a payload header in a GFP point-to-point frame;

FIG. 7 illustrates a payload header of a GFP ring frame;

FIG. 8 is a graph showing overhead produced when a user interface through HDLC framing is encapsulated into a ring frame and encapsulated into a point-to-point frame;

FIG. 9 illustrates conventional problems when many user streams are multiplexed and transferred;

FIG. 10 illustrates an example of a frame format of a GFP frame (GFP path frame) transferred by a GFP frame transfer apparatus according to a first embodiment of the present invention;

FIG. 11 is a block diagram showing an outlined configuration of the GFP frame transfer apparatus according to the first embodiment of the present invention;

FIG. 12 is a block diagram showing an example of a network system (GFP path frame network) made up of GFP frame transfer apparatuses;

FIG. 13 is a block diagram showing an example of a detailed configuration of a GFP edge node in the first embodiment of the present invention;

FIG. 14 is a block diagram showing a packet transfer example using a GFP path frame on a network (GFP path frame network) made up of the GFP nodes of the first embodiment of the present invention;

FIG. 15 is a flow chart showing a main operation of the GFP edge node when a user packet arrives from a subscriber network and the GFP path frame storing this user packet is sent to the GFP path frame network;

FIG. 16 is a flow chart showing a main operation of the GFP edge node when a GFP path frame arrives from a GFP path frame network and the user packet stored in the GFP path frame is sent to the subscriber network;

FIG. 17 is a block diagram showing an example of a detailed configuration of a GFP core node according to the first embodiment of the present invention;

FIG. 18(a) to (g) illustrates an address conversion table and packet transfer tables stored in memories in the GFP edge nodes and the GFP core nodes of the first embodiment shown in FIG. 14;

FIG. 19 is a graph that compares the amount of overhead produced when Gigabit Ethernet is accommodated as the subscriber network in the ring frame and the path frame in the first embodiment;

FIG. 20 is a block diagram illustrating a packet transfer example using a GFP path frame on a GFP path frame network made up of GFP nodes of a second embodiment of the present invention;

FIG. 21(a) to (c) illustrates an address conversion table stored in memory of the GFP edge node and packet transfer tables stored in memory of GFP core nodes of the second embodiment shown in FIG. 20; and

FIG. 22 illustrates an example of a comparison of a necessary bandwidth when a POS (packet over SONET) using an HDLC frame is accommodated as a subscriber network on the GFP network when a ring frame is used and when the path frame of the first embodiment is used.

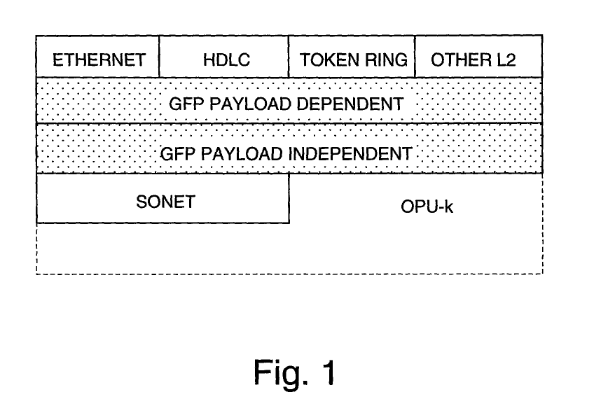

### DETAILED DESCRIPTION OF THE PREFERRED EMBODIMENTS

With reference now to the attached drawings, embodiments of the present invention will be explained in detail below.

(First Embodiment)

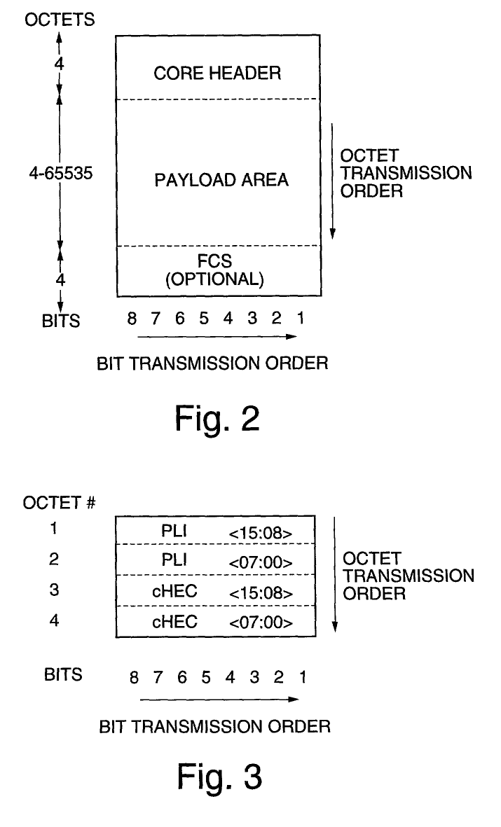

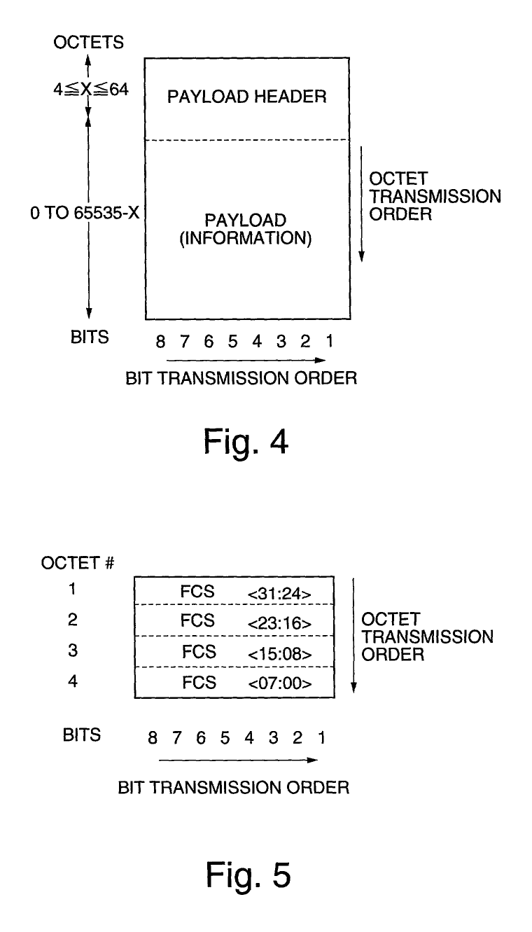

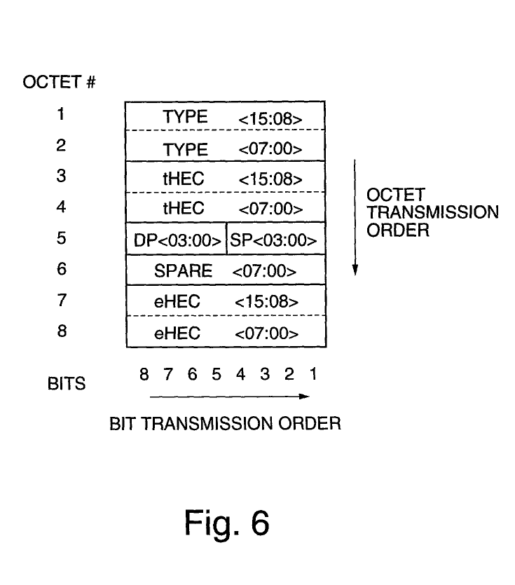

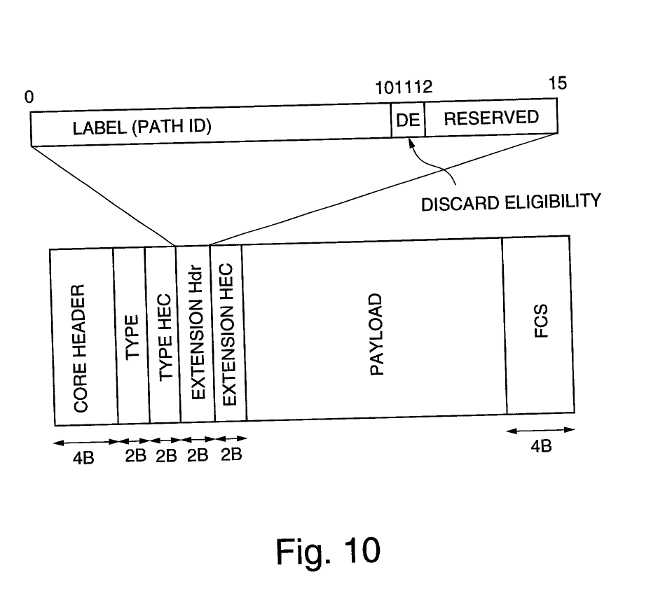

FIG. 10 illustrates an example of a frame format of a GFP frame (hereinafter referred to as “GFP path frame”) transferred by a GFP frame transfer apparatus according to a first embodiment of the present invention. The GFP path frame used in this embodiment has a configuration compliant with the conventional frame format for GFP frames shown in FIG. 2 to FIG. 5. The extension header area (area in the payload header excluding Type, tHEC and eHEC) is provided with a label field (11 bits), a DE (Discard Eligibility) field (1 bit) and a reserved field (4 bits).

When a GFP path frame of this embodiment is transferred, a path ID to uniquely identify the path from the source GFP node to the destination GFP node on the GFP network (hereinafter referred to as “GFP path frame network”) of this embodiment is defined instead of MAC addresses and port addresses (DP, SP) in a ring frame. The above-described label field stores a label value corresponding to this path ID.

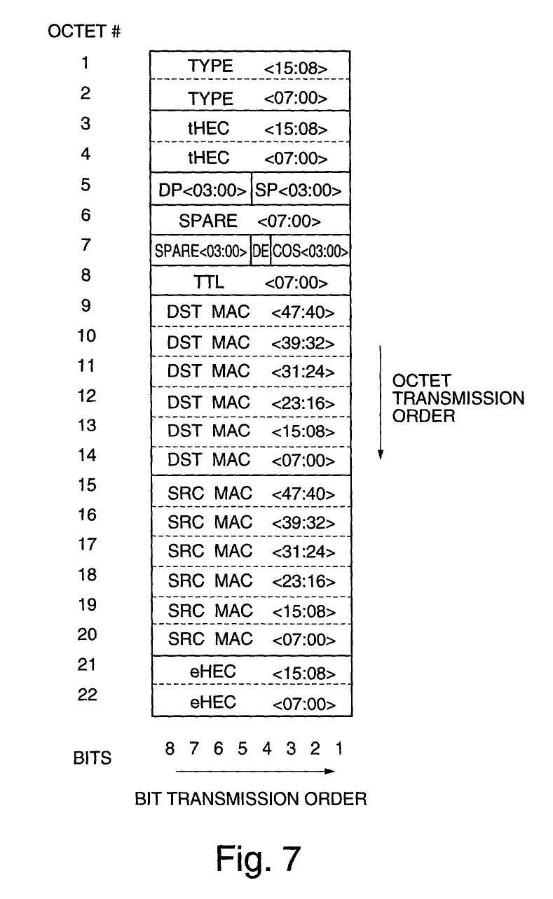

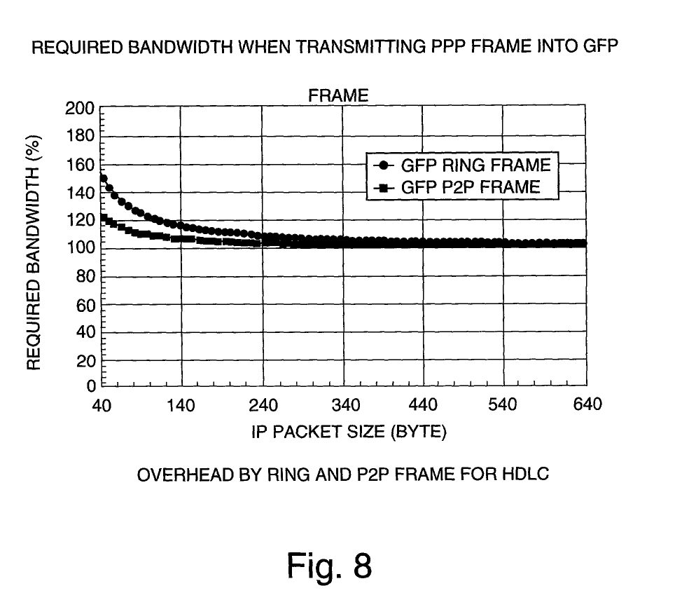

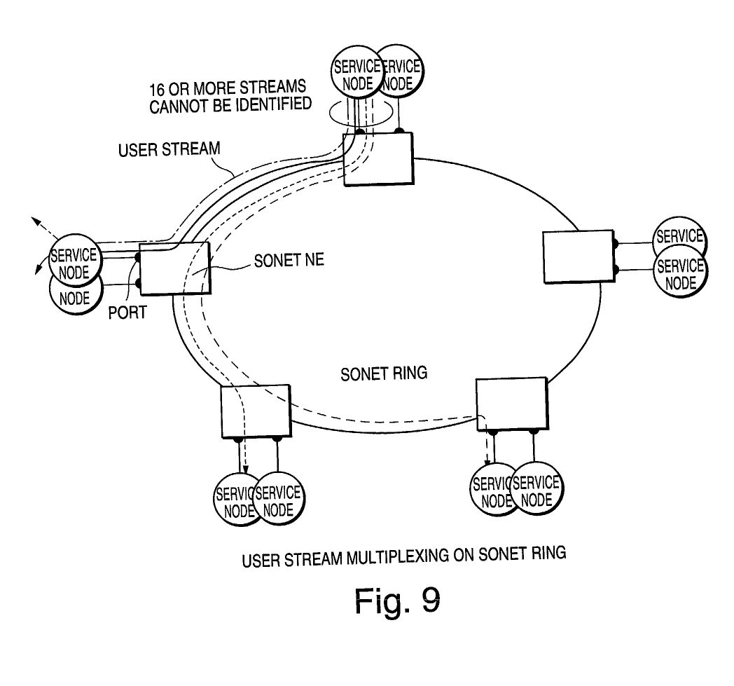

The above-described DE field is provided to show priority in discarding GFP path frames as in the case of the conventional ring frame shown in FIG. 7 and used for congestion control. The above-described reserved field is an area secured for reservation. In a connection-oriented frame transfer, frames are not looped and transferred during operation, and therefore the TTL field in the conventional ring frame is omitted.

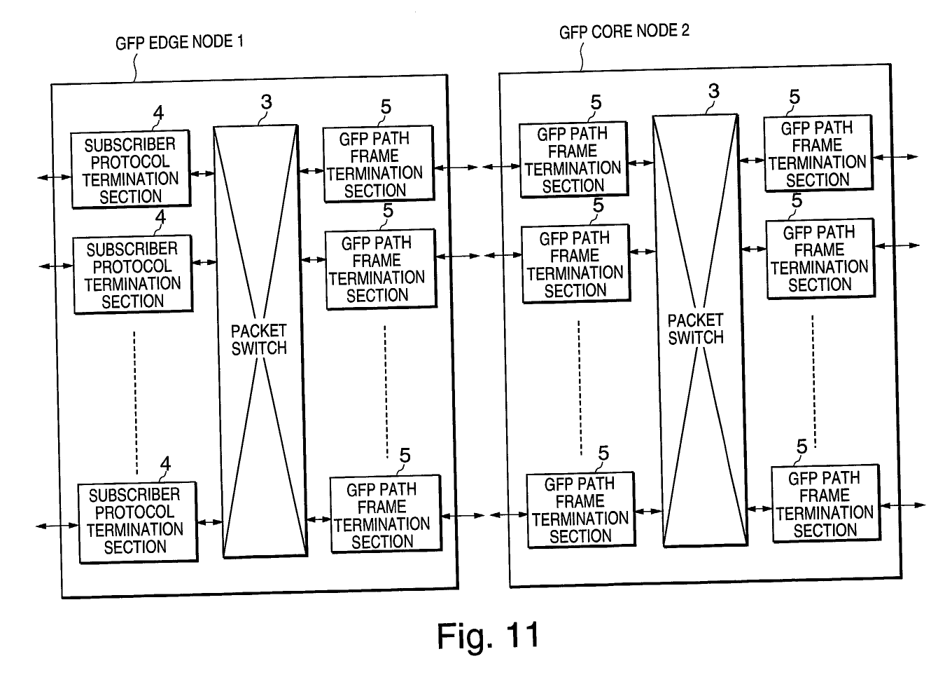

FIG. 11 is a block diagram showing an outlined configuration of the GFP frame transfer apparatus according to the first embodiment. FIG. 11 shows the GFP edge node 1 and GFP core node 2 in the first embodiment.

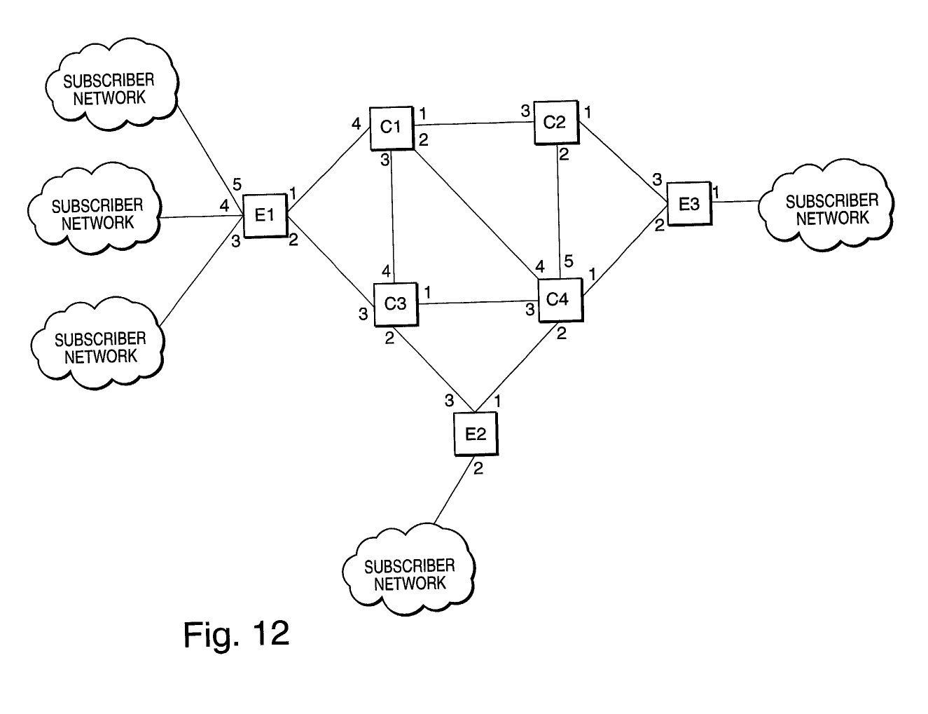

FIG. 12 is a block diagram showing an example of a network system (in this embodiment referred to as “GFP path frame network”) made up of the above-described GFP frame transfer apparatuses. In FIG. 12, a GFP path frame network is formed by three GFP edge nodes 1 (E1, E2 and E3) and four GFP core nodes 2 (C1, C2, C3 and C4). The GFP edge node 1 is connected with 1 or a plurality of subscriber networks (subnetworks) and the GFP core node 2 is not connected with any subscriber network.

The GFP edge node 1 shown in FIG. 11 is provided with a packet switch 3, a plurality of subscriber protocol termination sections 4 and a plurality of GFP path frame termination sections 5. Each termination section (4, 5) is mounted as a line card (LC), for example. The GFP core node 2 is provided with a packet switch 3 and a plurality of GFP path frame termination sections 5. The GFP core node 2 is not connected with any subscriber network, and therefore has no subscriber protocol termination section 4.

The subscriber protocol termination section 4 is the part that terminates a network protocol used in the subscriber network. The configuration and function of the subscriber protocol termination section 4 are changed according to the type of the subscriber network as appropriate. For example, when it is connected to a giga-bit Ethernet (GbE), the subscriber protocol termination section 4 performs frame termination processing of the giga-bit Ethernet. Furthermore, when it is connected to a POS (Packet over SONET) network, the subscriber protocol termination section 4 performs termination processing of a SONET frame and HDLC-like frame with a point-to-point protocol stored in this SONET frame.

The GFP frame termination section 5 is the part that terminates a first layer (physical layer) of an OSI reference model that accommodates the GFP frame in a network using the GFP frame (referred to as “GFP path frame network”). The configuration and function of the GFP path frame termination section 5 are changed according to the type of the first layer of the OSI reference model of the GFP path frame network as appropriate. For example, when SONET is used as the first layer of the OSI reference model and the GFP frame is mapped to the payload of the SONET frame (SPE (Synchronous Payload Envelope)), the GFP path frame termination section 5 performs processing such as termination of the SONET frame, extraction and mapping of the GFP frame. Furthermore, an OTN (Optical TransportNetwork) using a WDM (Wavelength Division Multiplex) is used as the first layer of the OSI reference model and when the GFP frame is mapped to an optical channel payload unit (OPUk) which is a payload of this OTN frame (digital wrapper), the GFP frame termination section 5 performs processing such as termination of the digital wrapper frame and extraction and mapping of the GFP frame for the OPUk.

The SONET standard is described in ANSI T1.105 and ANSI T1.105.02 or ITU-T G.707, while OPUk of OTN is described in ITU-T G.709.

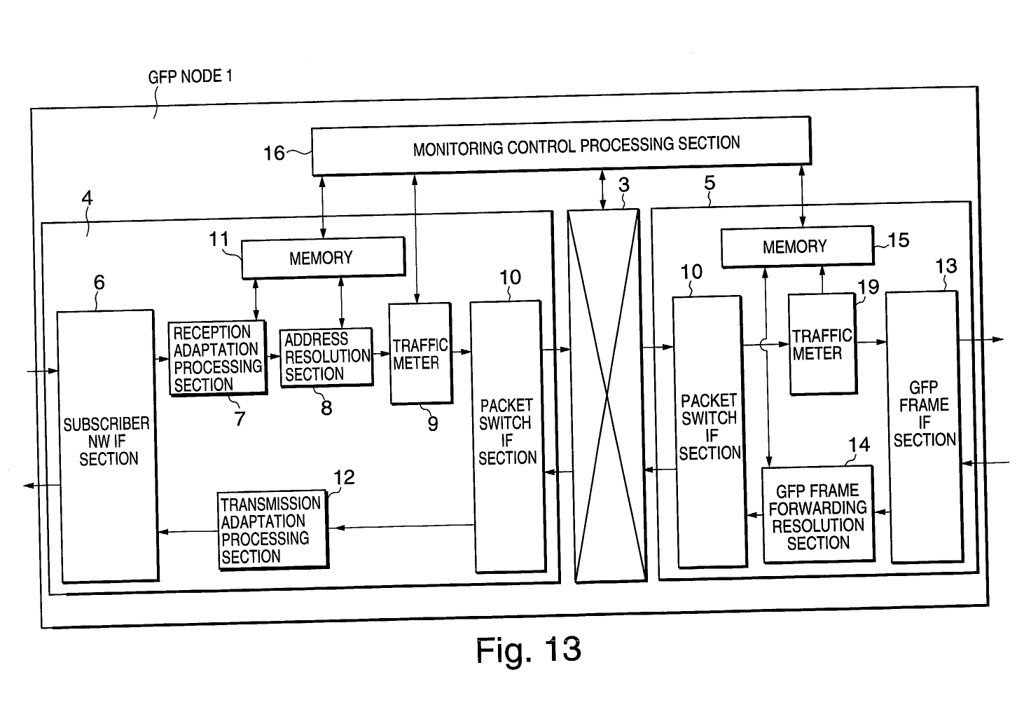

FIG. 13 is a block diagram showing an example of a detailed configuration of GFP edge node 1 in the first embodiment of the present invention. The GFP edge node 1 includes a monitoring control processing section 16 in addition to the sections described in FIG. 11. For brevity, the GFP node 1 in FIG. 13 shows one subscriber protocol termination section 4 and one GFP path frame termination section 5. However, one or more subscriber protocol termination sections 4 are provided for 1 or more subscriber network side ports of the GFP edge node 1 and one or more GFP frame termination sections 5 are provided for two GFP path frame network side ports and each termination section (4, 5) is connected to a packet switch 3.

The subscriber protocol termination sections 4 includes a subscriber network interface section 6, a reception adaptation processing section 7, an address resolution section 8, a traffic meter 9, a packet switch interface section 10, a memory 11 and a transmission adaptation processing section 12.

The subscriber network interface section 6 transmits/receives a user packet (a subscriber network frame storing a user packet) to/from the subscriber network. When a subscriber network frame storing a user packet is received from the subscriber network, the subscriber network interface section 6 terminates this subscriber network frame, removes unnecessary overhead for the subscriber network from this subscriber network frame, extracts the user packet and sends this user packet to reception adaptation processing section 7. Furthermore, the subscriber network interface section 6 also sends a user packet to the subscriber network as will be described later.

Reception adaptation processing section 7 adds “Type” which is the field of the GFP frame for adaptation to the user packet received from the subscriber network interface section 6, performs a CRC16 calculation on this Type, adds “tHEC” and secures an area for the extension header. Hereafter, a GFP frame being formed based on the user packet will also be referred to as “GFP path frame”.

The address resolution section 8 refers to the memory 11 based on the destination address (User Destination Address) of the subscriber network stored in the user packet stored in the payload field of this GFP path frame, identifies the path ID on this GFP path frame network, adds a GFP path frame transfer label to the extension header area of the GFP path frame based on this, performs a CRC16 calculation on this extension header area and adds “eHEC” thereto. The address resolution section 8 also identifies the output port corresponding to the path ID in the packet switch 3 in this node. This destination address (User Destination Address) of the subscriber network refers to the “Destination Address (DA)” when the above-described user packet is an Ethernet MAC frame or an IP packet extracted from the payload of an HDLC frame of POS.

The traffic meter 9 monitors a flow of excessive traffic that exceeds a bandwidth set for each path ID by the monitoring control processing section 16. If the bandwidth is exceeded, the traffic meter 9 instructs the section that controls the reading of a GFP path frame (packet switch interface section 10) to discard the GFP path frame or carry out polishing control to reduce the reading priority order.

The packet switch interface section 10 has the function of controlling the packet switch 3 according to a scheduling function that changes the transfer frequency depending on the amount of network resources assigned to the path ID to which the packet belongs.

The memory 11 stores the “User Destination Address (User Dest Addr”, which is the destination address on the subscriber network, “SONET Destination Address (SONET Dest Addr)”, which is the destination node address on the GFP path frame network, “Ingress Port” that indicates the input port at the relevant node, “Egress Label”, which is the label at the output destination for identification of the path to be added to the GFP path frame and “Egress port” that indicates the output port at the relevant node. This information is set from the monitoring control processing section 16.

The transmission adaptation processing section 12 removes the payload header (Type, tHEC, extension header, eHEC) from the GFP frame which is switched by the packet switch 3, transferred to the subscriber protocol termination section 4 and supplied via the packet switch interface section 10 and transfers it to the subscriber network interface section 6.

The subscriber network interface section 6 that has received the packet (hereinafter referred to as “user packet”) stored in the payload of the payload area of the GFP path frame from the transmission adaptation processing section 12 adds overhead for the subscriber network to this user packet, stores this in the frame of the subscriber network and sends the frame storing this user packet to the subscriber network.

On the other hand, the GFP path frame termination section 5 has a GFP path frame interface section 13, a GFP path frame forwarding resolution section 14, a packet switch interface section 10, a traffic meter 19 and a memory 15.

The GFP path frame interface section 13 transmits/receives the GFP path frame (SONET frame that stores the GFP path frame) to/from the GFP path frame network. When the GFP path frame interface section 13 receives the SONET frame that stores the GFP path frame, the GFP path frame interface section 13 extracts the GFP path frame from the SONET frame, removes the core header from the GFP path frame, performs descrambling processing and carries out an FCS check, and transfers this GFP path frame to the GFP path frame forwarding resolution section 14. Furthermore, the GFP path frame is also sent to the GFP path frame network as will be described later.

The GFP path frame forwarding resolution section 14, based on the extension header of the GFP path frame received from the GFP path frame interface section 13, specifies the output port of the packet switch 3.

The packet switch interface section 10 has almost the same function as that of the packet switch interface section 10 in the subscriber protocol termination section 4.

The memory 15 stores “Ingress Label” which is the label of the GFP path frame input and “Egress port” which is the output destination port for each path ID. This information is set from the monitoring control processing section 16.

The traffic meter 19 monitors a flow of excessive traffic that exceeds a band set for each path ID by the monitoring control processing section 16. As a result, if the band is exceeded, the traffic meter 19 instructs the section that controls a GFP path frame read (GFP path frame interface section 13) to discard the GFP path frame or carry out polishing control to reduce the read priority order.

The GFP path frame is switched by the packet switch 3, transferred to the GFP frame termination section 5 and supplied via the packet switch interface section 10 and the traffic meter 19. The GFP path frame interface section 13 that has received the GFP path frame adds an FCS (Frame Check Sequence) field that indicates the result of an FCS calculation carried out on the payload area of this GFP path frame, adds a core header and carries out scrambling processing. The GFP path frame interface section 13 then stores this GFP path frame in the payload of the SONET frame and sends the SONET frame in which this GFP frame is stored to the GFP path frame network.

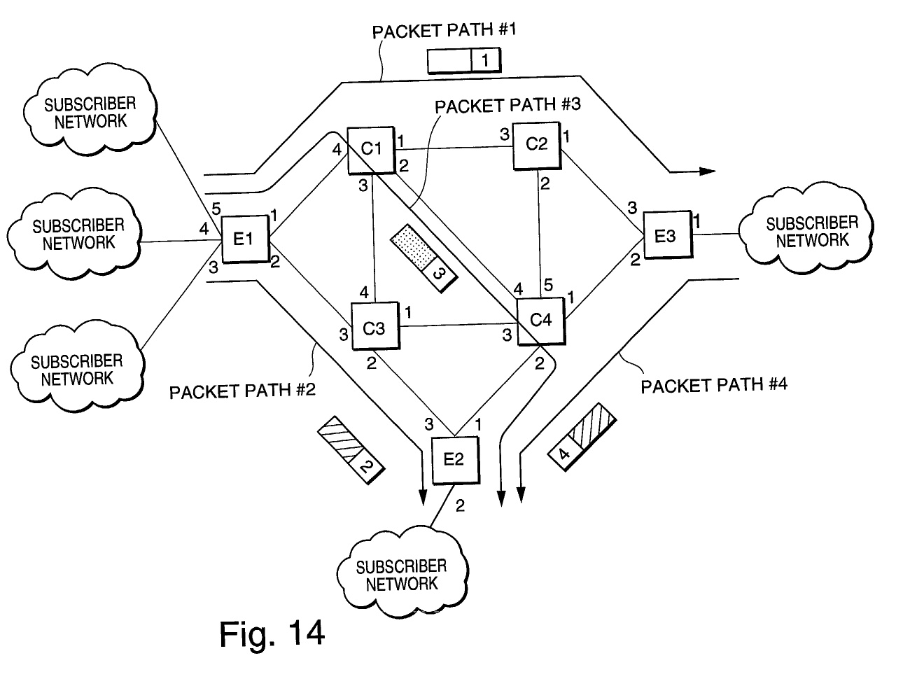

FIG. 14 shows a packet transfer example using the GFP path frame on the network (GFP path frame network) made up of the GFP nodes according to Embodiment 1 of the present invention.

The GFP path frame network shown in FIG. 14 consists of three GFP edge nodes 1 (E1, E2 and E3) and four GFP core nodes 2 (C1, C2, C3 and C4). Each GFP edge node 1 interfaces with a subscriber network. Each GFP edge node has a plurality of ports and the ports are assigned their respective port numbers.

This GFP path frame network is provided with four packet paths. This embodiment assumes that each path is unidirectional, but it is also possible to define each path as bi-directional. A packet path with path ID=1 will be explained by way of example. This packet path specifies a route from the port 5 of the GFP edge node E1, via GFP core nodes C1 and C2 to the port 1 of the GFP edge node E3. The other paths ID=2, 3 and 4 also show the routes as described in FIG. 14. This embodiment will be explained assuming that SONET is used as the first layer of the OSI reference model on the GFP path frame network.

This embodiment adopts a global label system which assigns a label to be added to the GFP path frame for each path ID uniquely throughout the GFP path frame network. That is, a fixed value to identify the path is added to the label of the packet transferred through each path and the value of the label is not changed within the GFP path frame network. For example, number 1 is assigned to the label of the packet transferred through the path with packet path ID=1 and the value of the label is not changed within the GFP path frame network.

An operation in the GFP edge node 1 according to this embodiment will be explained in detail using FIG. 13, etc.

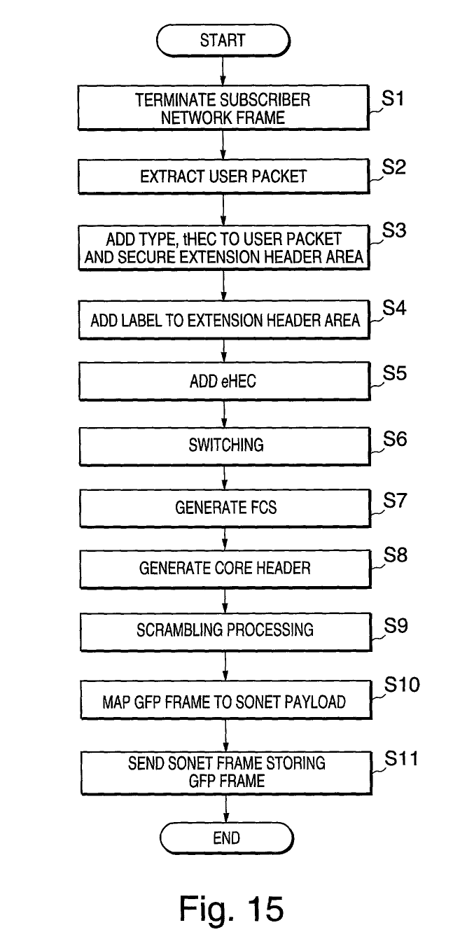

First, an operation of the GFP edge node 1 when a user packet arrives from the subscriber network and the GFP path frame storing this user packet is sent to the GFP path frame network will be explained using FIG. 13 and FIG. 15. FIG. 15 is a flow chart showing a main operation of the GFP node 1 in the above-described case.

When a user packet (subscriber network frame storing a user packet) arrives at a subscriber protocol termination section 4 of the GFP edge node 1, the subscriber network interface section 6 in the subscriber protocol termination 4 performs termination processing on this subscriber network frame (step S1) and extracts the user packet (step S2). In this case, the subscriber network interface section 6 extracts the user packet by removing unnecessary overhead for the subscriber network from the subscriber network frame. This unnecessary overhead indicates, for example, when the subscriber network frame is an Ethernet MAC frame, its “Preamble” and “Start of Frame Delimiter”.

When this user packet is transferred to the reception adaptation processing section 7, the reception adaptation processing section 7 sets a value indicating the protocol type (Ethernet, Token Ring, HDLC, etc.) of this packet or a value indicating that a ring frame, and path frame format will be used in the Type field of GFP, secures an area necessary for the extension header and adds it to this packet (step S3) (hereinafter a GFP frame being formed based on the user packet will also be referred to as “GFP frame”).

Then, when the GFP path frame is transferred to the address resolution section 8, the address resolution section 8 searches for the destination address information (User Dest Addr) in the user packet stored in the payload field of this GFP frame or searches for the packet path information stored in the memory 11 from “User Dest Addr” and the input port “Ingress port” which is the input port at the relevant node, identifies the path ID and identifies the label (Egress Label) to be added to the GFP path frame and the output port (Egress Port) of the packet switch 3 at the own node based on this. The address resolution section 8 sets the searched label value in the label field of the extension header area (step S4) and performs a CRC16 calculation on this extension header area to add “eHEC” (step S5).

Then, when the GFP path frame is transferred to the traffic meter 9, the traffic meter 9 monitors a flow of excessive traffic that exceeds the band set for every path ID by the monitoring control processing section 16, for example. As a result, if the band is exceeded, the traffic meter 9 instructs the packet switch interface section 10 to discard the GFP frame or perform polishing control to reduce the read priority order.

Then, when the GFP path frame is transferred to the packet switch interface section 10, the packet switch interface section 10 controls the packet switch 3 according to the scheduling function to change the transfer frequency depending on the amount of network resources assigned to a path ID that the GFP path frame belongs to, and transfers the GFP path frame from the subscriber protocol termination section 4 to the packet switch 3.

The GFP path frame is switched by the packet switch 3 (step S6), transferred to the GFP path frame termination section 5 (corresponding to the output port of the packet switch 3 of the own node (Egress Port)) which is the switch destination. The GFP path frame arrives at the traffic meter 19 via the packet switch interface section 10 inside the GFP path frame termination section 5 and the traffic meter 19 performs the above-described band monitoring, flow rate restriction and priority control.

When the GFP path frame is transferred to the GFP path frame interface section 13, the GFP path frame interface section 13 performs generation of an FCS (Frame Check Sequence) field (step S7), generates a core header (step S8), performs scrambling processing (step S9). Then, it maps the GFP path frame to the SONET payload (payload of SONET frame) used in this GFP path frame network (step S10). Then, the SONET frame storing this GFP path frame is sent from the GFP path frame termination section 5 to the GFP network (step S11).

In this embodiment, suppose the GFP path frame interface section 13 adds/removes the core header of the GFP path frame in the GFP edge node 1 and the GFP path frame without the core header is transferred or processed within the GFP edge node 1. As the method of transmitting information showing the length (delimitation) of the GFP path frame within the GFP edge node 1, various methods can be used such as transferring a length-related numerical value added to the GFP path frame (transferred multiplexed or as a different signal) as control information, adding a flag (Flag Bits) indicating the start and end of the GFP path frame, sending a signal (Enable signal etc.) indicating the signal part in which the GFP path frame exists in parallel, etc. It is also possible to transfer and process the GFP path frame with the core header added thereto within the GFP edge node 1.

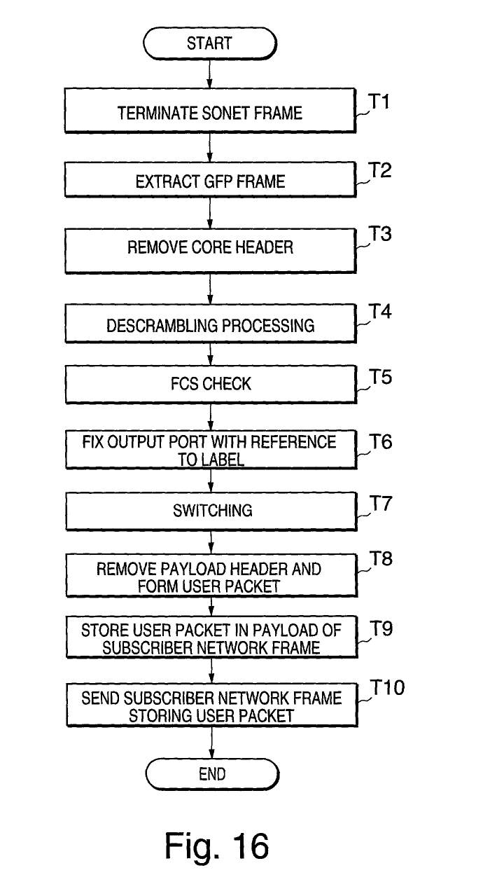

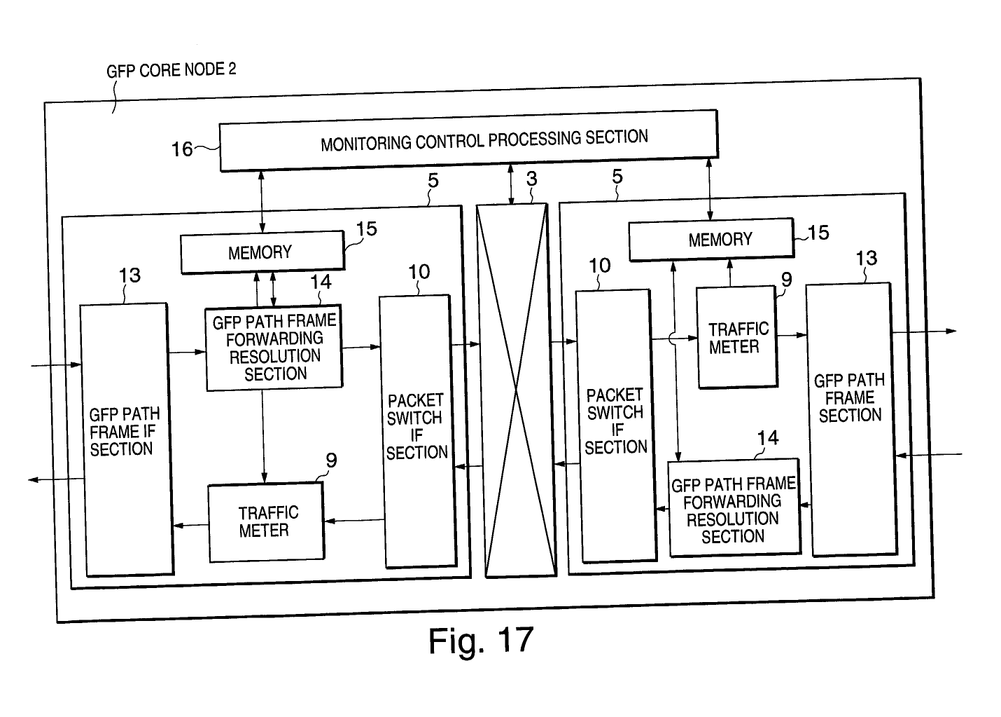

Then, an operation of the GFP edge node 1 when the GFP path frame arrives from the GFP path frame network and the user packet stored in this is sent to the subscriber network will be explained using FIG. 13 and FIG. 16. FIG. 16 is a flow chart showing a main operation of the GFP edge node 1 in the above-described case. When the GFP path frame (SONET frame storing the GFP path frame) arrives at the GFP path frame termination section 5 on the west side or east side in the GFP edge node 1, the GFP path frame interface section 13 in the GFP path frame termination section 5 terminates the SONET frame (step T1) and extracts the GFP frame (delineation) (step T2). The GFP path frame termination section 5 also removes the core header from the GFP frame (step T3), performs descrambling processing (step T4) and carries out an FCS field check for the GFP frame (FCS check) (step T5).

When the GFP path frame is transferred to the GFP path frame forwarding resolution section 14, the GFP path frame forwarding resolution section 14 searches for the packet path information stored in the memory 15 based on the label in the extension header of the GFP path frame, identifies the path ID and identifies the output destination (Egress Port) in this node based on this (step T6).

Then, when the GFP path frame is transferred to the packet switch interface section 10, the packet switch interface section 10 controls the packet switch 3 according to the scheduling function that changes the transfer service frequency depending on the amount of network resources as signed for a path ID that the GFP path frame belongs to and transfers the GFP path frame from the GFP path frame termination section 5 to the packet switch 3.

The GFP path frame is switched by the packet switch 3 and transferred to the subscriber protocol termination section 4, to which switching is made (step T7). In the subscriber protocol termination section 4, the GFP path frame arrives at the transmission adaptation processing section 12 via the packet switch interface section 10. The transmission adaptation processing section 12 deletes the payload header (Type field, tHEC, extension header area, eHEC), forms a user packet (step T8) and transfers this user packet to the subscriber network interface section 6.

The subscriber network interface section 6 maps (addition of overhead etc.) the user packet stored in this payload field and transferred to the payload of the subscriber network frame (step T9). Then, the subscriber network frame storing this user packet is sent from the subscriber protocol termination section 4 to the subscriber network connected thereto (step T10).

Then, an operation of the GFP node 1 when the GFP path frame arrives from the GFP path frame network or the GFP path frame is sent to the GFP path frame network will be explained.

When the GFP path frame (SONET frame storing the GFP frame) arrives at a GFP path frame termination section 5 on the west side or east side in the GFP edge node 1, the GFP path frame interface section 13 in the GFP path frame termination section 5 terminates the SONET frame and extracts the GFP frame (delineation). It also removes the core header from the GFP frame, performs descrambling processing and carries out a GFP frame FCS check.

Then, the same processing as that of the GFP path frame termination section 5 in the above-described case of GFP path frame reception is performed and this GFP path frame is switched by the packet switch 3 and transferred to the GFP path frame termination section 5 corresponding to the output destination port (Egress Port).

The GFP path frame termination section 5 at the switching destination then carries out almost the same processing as that of the GFP path frame termination section 5 in the above-described case of GFP path frame transmission and this GFP frame (SONET frame storing the GFP path frame) is sent to the GFP path frame network.

FIG. 17 is a block diagram showing an example of a detailed configuration of a GFP core node 2 according to this embodiment. The GFP core node 2 has admonition control processing section 16 in addition to the sections shown in FIG. 11. For brevity, the GFP core node 2 in FIG. 17 shows only two GFP path frame termination sections 5, but one or more GFP path frame termination sections 5 are provided for one or more ports on the GFP path frame network side of the GFP core node 2. The respective GFP path frame termination sections 5 are connected to the packet switch 3.

The operation of the GFP core node 2 is carried out in the same way as the operation of the above-described GFP edge node 1 that receives the GFP path frame from the GFP path frame network and sends the GFP path frame to the GFP path frame network.

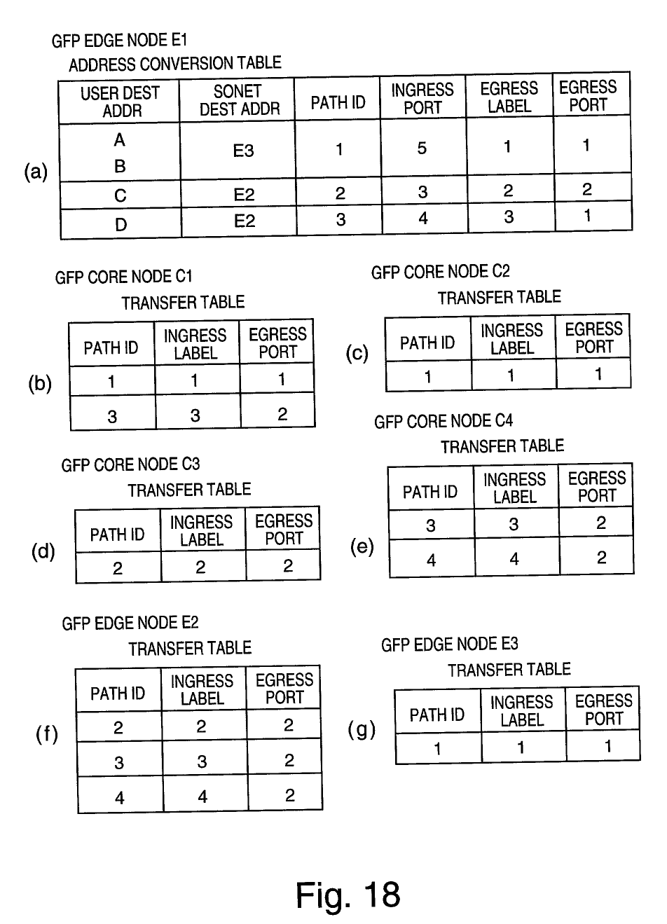

FIG. 18A to 18G illustrate an address conversion table and packet transfer tables stored in the memories 11 and 15 in the GFP edge nodes E1, E2 and E3 and the GFP core nodes C1, C2, C3 and C4 of this embodiment shown in FIG. 14.

First, the address conversion table of the GFP edge node E1 shown in FIG. 18A will be explained. If the destination address (User Dest Addr) in the user packet is “A”, the destination node (SONET Dest Addr) in the corresponding GFP path frame network is identified as “E3” and path ID is identified as “1”. At the same time, it is found that the label value (Egress Label) to be added to the GFP path frame is “1” and the output port number (Egress Port) of the switch in this node is “1”.

In this example, if the destination address in the user packet is “B”, the destination node, path ID, label value and the output port number of the switch in this node are the same as those in the case of “A”. In this example, the path ID is identified only based on the destination address (User Dest Addr) in the user packet, but it is also possible to identify the path ID based on two pieces of information, the destination address (User Dest Addr) and the input port (Ingress port) for this GFP edge node 1 of the user packet.

Then, the transfer table of the GFP core node C1 shown in FIG. 18B will be explained. If the label value (Ingress Label) of the GFP path frame input is “3”, it is found that the corresponding GFP path frame belongs to the packet path with the ID “3” which is the same value and the output port number (Egress port) of the switch which is the transfer destination is “2”.

By the way, when the destination address (User Dest Addr) in the user packet is a global address (when addresses are assigned without duplication throughout a plurality of subscriber networks), the path ID is uniquely determined from this destination address (User Dest Addr). For this reason, the item “Ingress port” (related to the input port of the relevant GFP core node C1) is not necessary.

When the destination address (User Dest Addr) in the user packet is a local address (addresses are assigned without duplication in each subnetwork (each subscriber network), but there can be duplicate addresses throughout a plurality of subnetworks), if the destination of the port is one subnetwork, the path ID is determined from “User Dest Addr” and “Ingress port”.

As described above, this first embodiment uses a global label system which assigns a label to be added to the GFP path frame which belongs to this uniquely throughout the entire GFP path frame network and does not change the label value. For this reason, in FIG. 14, with the label 1 added at the GFP edge node E1, the GFP path frame that belongs to the packet path #1 is transferred with this label 1 retained. Therefore, the GFP path frame is transferred to GFP core node C1, GFP core node C2 and GFP edge node E3 and transferred to the subscriber network ahead of the port 1 of the GFP edge node E3 (see “Egress Port” corresponding to the label (Ingress Label) 1 in FIG. 18A, B, C and G).

Likewise, with the label 2 added at the GFP edge node E1, the packet that belongs to the packet path #2 is transferred with this label 2 retained. Therefore, the packet is transferred to GFP core node C3, GFP edge node E2 and transferred to the subscriber network ahead of the port 2 of the GFP edge node E2 (see “Egress Port” corresponding to the label (Ingress Label) 2 in FIG. 18A, D and F).

Likewise, with the label 3 added at the GFP edge node E1, the packet that belongs to the packet path #3 is transferred with this label 3 retained. Therefore, the packet is transferred to GFP core node C1, GFP core node C4, GFP edge node E2 and transferred to the subscriber network ahead of the port 2 of the GFP edge node E2 (see “Egress Port” corresponding to the label (Ingress Label) 3 in FIG. 18A, B, E and F).

As described above, the label of the GFP path frame transferred through each packet path is assigned a fixed value to identify the path and the value of the label is not changed in the GFP path frame network. AT each GFP core node 2, switching is performed with reference to the value of this label.

As shown above, the GFP frame transfer apparatus and GFP frame transfer method according to this first embodiment adds a label corresponding to the path ID set to uniquely identify the path from the source GFP node within the GFP path frame network to the destination GFP node to the label field of the extension header area of the GFP path frame and transfers the GFP path frame via each GFP node on the path based on this label, and can thereby perform flexible routing also on complicated network topologies. Furthermore, the use of this label makes it possible to easily multiplex and transfer different user streams at each GFP node (Ingress node, relay node).

Unlike the point-to-point frame or ring frame, the GFP path frame of this embodiment is also applicable to complicated network topologies such as mesh-shaped and multi-ring-shaped topologies, thus providing flexible end-to-end transfers. Thus, the adaptation using the GFP path frame is applicable to multiple topologies and is therefore naturally applicable to existing point-to-point connections and ring connections.

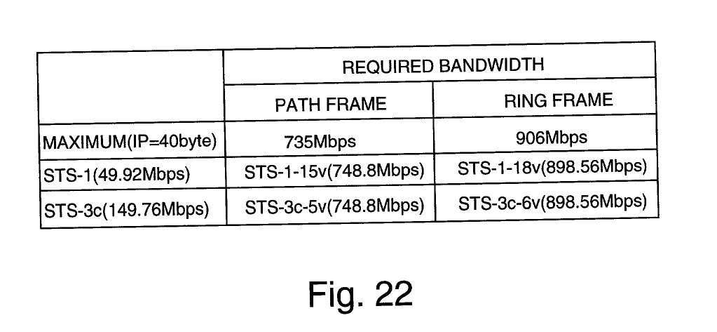

FIG. 22 illustrates an example of a comparison of a necessary bandwidth when a POS (packet over SONET) using an HDLC frame is accommodated as a subscriber network on the GFP network when a ring frame is used and when the path frame of the first embodiment is used.

As is apparent from FIG. 22, the use of the path frame of this embodiment can reduce overhead drastically compared to the case where a ring frame is used. When HDLC traffic at an average rate of 600 Mbps is accommodated using virtual concatenation by STS-1 (50 Mb/s), STS-1-18v is required in the case of a ring frame, whereas STS-1-15v is enough in the case of a path frame. Furthermore, in the case of accommodation using virtual concatenation by STS-3c (150 Mb/s), STS-3c-6v is required in the case of a ring frame, whereas STS-3c-5v is enough in the case of a path frame. The definition of virtual concatenation, etc. is described in (3.72, (7.3.2 and (7.3.3 in the document “T1X1.5/2000-193R1” in T1X1.5.

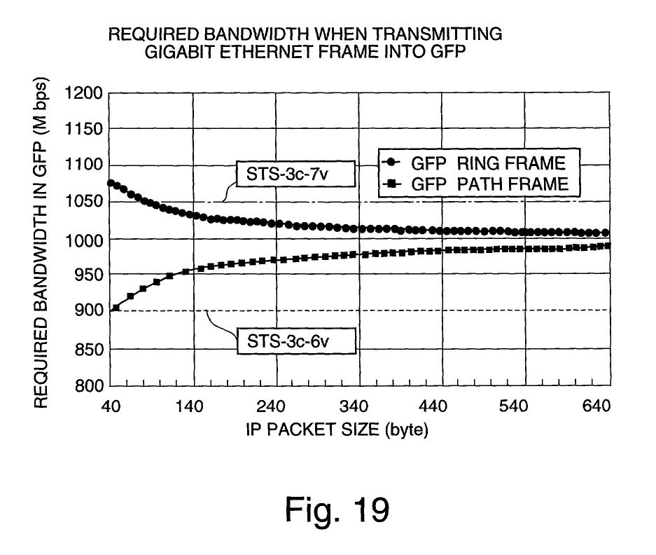

FIG. 19 is a graph that compares the amount of overhead produced when Gigabit Ethernet is accommodated as the subscriber network in the ring frame and the path frame of this embodiment. As is apparent from FIG. 19, through the accommodation using the path frame of this embodiment, it is possible to drastically reduce overhead compared to the accommodation using a ring frame. In the case of the ring frame, as a packet becomes shorter, even STS-3c-7v (=1048.32 Mbps) may not be able to provide a sufficient bandwidth. In the case of the path frame, STS-3c-7v can accommodate sufficiently and the short packet side can have enough capacity.

A path ID can be specified for only traffic between GFP nodes within the GFP path frame network, but it can also be specified for traffic between tributary (user network, etc.) nodes as shown in the above-described embodiment. Therefore, individual user streams at the Egress node can be identified or separated by only the GFP layer and furthermore the user traffic can be identified or separated without the need for processing of still higher layers (IP layer, etc.).

(Second Embodiment)

Then, a second embodiment of the present invention will be explained.

In the second embodiment, unlike the first embodiment, a label swapping system is adopted which changes the label value as appropriate every passage of the GFP node (1, 2).

Thus, the content of the table stored in the memory 15 in the GFP path frame termination section 5 in FIG. 13 and FIG. 17 is different from that of the first embodiment. The memory 15 stores the input port “Ingress port” at the relevant node and the label “Egress Label” at the output destination for every path ID in addition to the label “Ingress Label” at the input port and output destination port “Egress port” at the relevant node used in the first embodiment.

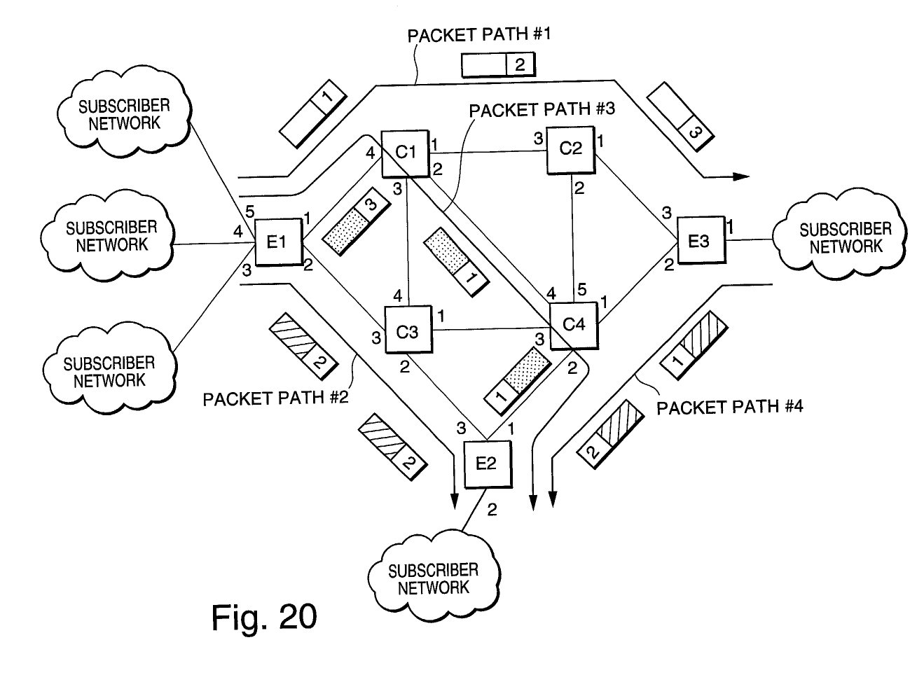

FIG. 20 shows a packet transfer example using a GFP path frame on a GFP path frame network made up of GFP nodes of this second embodiment.

The GFP path frame network of the second embodiment has the same node layout, number of packet paths set and route as those of the GFP path fame network in the first embodiment. As for the operation, the second embodiment is different from the first embodiment in that the value of the label added to the GFP path frame may be changed by the node as appropriate every time the path frame passes through the node.

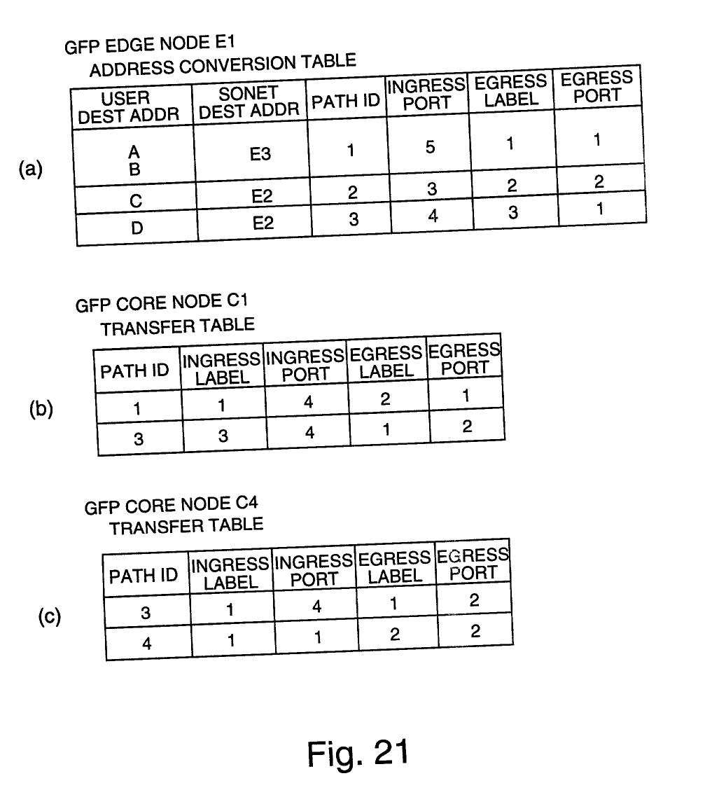

FIG. 21A to 21C show an address conversion table stored in the memory 11 of the GFP edge node E1 and packet transfer tables stored in the memory 15 of GFP core nodes C1 and C4 of this embodiment shown in FIG. 20.

For example, the GFP path frame that belongs to packet path #1 is given the label value (Egress Label) “1” at the GFP edge node E1, transferred to the GFP core node C1 and given the label value (Egress Label) “2” corresponding to Ingress Label “1” at the GFP core node C1 and transferred to the GFP core node C2. The GFP path frame is given the label value (Egress Label) “3” corresponding to Ingress Label “2” at the GFP core node C2, transferred to the GFP edge node E3 and transferred to a subscriber network ahead of the port 1 of the GFP edge node E3.

In order to realize this label swapping function, the processing in the GFP node (1, 2) is also changed to some extent compared to the first embodiment. More specifically, the operation of the GFP path frame forwarding resolution section 14 in the GFP path frame termination section 5 is slightly different.

When the GFP path frame is transferred to the GFP path frame forwarding resolution section 14, the GFP path frame forwarding resolution section 14 searches for the packet path information stored in the memory 15 based on the label value (Ingress Label) at the time of input of the input port (Ingress port) and the GFP path frame at the relevant node, identifies the path ID and identifies a new label value “Egress Label” to be added to the GFP path frame and the output destination “Egress Port” in this node. The searched “Egress Label” is swapped (Label swap) with “Ingress Label” of the GFP path frame.

The rest of operation is carried out in the same way as in the first embodiment and the GFP path frame is transferred.

As described above, with regard to the GFP frame transfer apparatus and GFP frame transfer method according to this second embodiment, it is possible to produce effects obtained in the first embodiment by adopting the label swapping system. Therefore, it requires fewer labels than a global label system and when a label area with the same number of bits is used, it is possible to increase the number of paths that can be identified and used and accommodate more subscribers compared to the first embodiment.

The above embodiment shows the case where SONET is used as the first layer of the OSI reference model on the GFP path frame network, but similar transfers are also possible using WDM (OTN).

Furthermore, in the foregoing embodiments, the frame conforming to the format of the GFP path frame shown in FIG. 10 is transferred and processed as a common frame in the apparatus (GFP edge node 1, GFP core node 2). In contrast to this, it is also possible to define an independent apparatus internal frame and transfer and process this frame within the apparatus.

The foregoing embodiments have explained the GFP path frame taking the frame format in FIG. 10 as an example, but it is naturally possible to adopt a different frame format if it is at least a GFP path frame provided with the above-described label field. For example, it is possible to make various modifications such as providing a COS (Class Of Service) field for a certain number of bits of the label field or the Reserved field and using the COS field for priority control, or providing a DP (Destination Port) field and describing the output port at the Egress node, etc.

In the foregoing embodiments, the length of the extension header area of the GFP path frame is assumed to be 16 bits, but this can be set to 8 bits or 24 bits, etc. and in either case, it is possible to drastically reduce overhead compared to the case using a GFP ring frame whose extension header has a length of 16×8=128 bits. For example, if the length of the extension header area is 8 bits and a 5-bit label field is provided therein, it is possible to set labels corresponding to 32 path IDs and provision of a 6-bit label field allows labels corresponding to 64 path IDs to be set and this setting is sufficiently operable for the GFP network of a certain scale. In this way, it is possible to change the GFP path frame format as appropriate according to the design requirements, etc. of the GFP network.

Path IDs in the foregoing embodiments are uniquely set within the GFP path frame network in order to uniquely specify the path from the Ingress node to Egress node within the GFP path frame network, but when an end-to-end path is set or released in the operation of the GFP path frame network, it is naturally possible to use a method of changing the path ID setting over time.

As shown above, according to the GFP frame transfer apparatus of the present invention, the GFP frame transfer apparatus for transferring a GFP frame comprises a GFP path frame forming means for storing a label corresponding to a path ID defined to uniquely specify the path from the Ingress node to Egress node in the GFP network made up of a plurality of GFP nodes in a predetermined field in the extension header area of the GFP frame, storing a packet to be transferred via the path in the payload field of the GFP frame and forming a GFP path frame. This allows each relay node to switch or transfer the GFP path frame using the label corresponding to this path ID. Thus, unlike the case of a point-to-point frame or ring frame, it is possible to perform flexible routing for complicated network topologies such as mesh-shaped and multi-ring-shaped topologies and realize flexible end-to-end transfers. Thus, the adapration using the GFP path frame is applicable to multiple topologies and is therefore naturally applicable to existing point-to-point connections and ring connections.

Furthermore, the use of this label makes it possible to easily multiplex and transfer different user streams at each GFP node (Ingress node, relay node). A path ID can be specified for only traffic between GFP nodes within the GFP path frame network, but it can also be specified for traffic between tributary (user network, etc.) nodes as shown in the above-described embodiment. Therefore, individual user streams at the Egress node can be identified or separated by only the GFP layer and the user traffic can further be identified or separated without the need for processing of a still higher layer (IP layer, etc.).

Furthermore, the extension header area in the GFP path frame can be set to an extremely short length compared to the GFP ring frame (length of extension header: 16×8=128 bits), for example, 16 bits. Therefore, it is possible to drastically reduce overhead compared to the case where the GFP ring frame is used. It is also possible to drastically reduce overhead accompanying the encapsulation when the subnetwork such as a subscriber network is accommodated in the GFP network compared to the case where the GFP ring frame is used and drastically reduce net expansion and reduce link costs.

The extension header area is provided with a label field to store the above-described labels, a DE (Discard Eligibility) field to store flags indicating priority of discarding GFP path frames and a reserved field for reservation. The size of each field can be 11 bits, 1 bit and 4 bits, for example. The size of the label field can be determined according to the number of paths (path IDs) to be set on the GFP path frame network. If the size of the label field is set to 11 bits as in the above-described embodiment, for example, it is possible to set 2048 paths (path IDs) on the GFP path frame network and set 32 5-bit paths (path IDs). Furthermore, setting the priority of discarding GFP path frames in the DE field allows each GFP node to determine whether or not to discard a GFP path frame when traffic is congested or when an FCS check detects a GFP path frame error, etc. with reference to the DE field. Furthermore, it is also possible to allow the GFP path frame to have other various functions using the reserved field.

It is possible to accommodate Ethernet, POS (Packet Over SONET), etc. as the subnetwork. When Ethernet is accommodated as a subnetwork, for example, the packet extracting means of the GFP frame transfer apparatus can terminate the Ethernet frame of this Ethernet, extract a packet from the payload of this Ethernet frame, store this packet in the payload field of the GFP path frame and send it to the GFP path frame network. On the other hand, when POS is accommodated as a subnetwork, for example, the packet extracting means of the GFP frame transfer apparatus can terminate the HDLC frame of this POS, extract the packet from the payload of this HDLC frame, store this packet in the payload field of the GFP path frame and send it to the GFP path frame network. The packet is extracted by the packet extracting means, for example, by removing unnecessary overhead for the subnetwork from the frame of the subnetwork. Thus, it is possible to accommodate a wide range of applications by accommodating various protocols.

When the GFP path frame forming means specifies the label corresponding to the path ID on the GFP network, it is possible to specify the label based on, for example, the routing information stored in the packet or the routing information stored in the packet and the input port when the packet is input to the GFP frame transfer apparatus. As this routing information, if an Ethernet MAC frame is accommodated as the packet, DA (Destination Address) stored in this Ethernet MAC frame can be used or also when an IP packet is accommodated as the packet, DA (Destination Address) stored in this IP packet can be used.

When the GFP path frame transmitting means sends the GFP path frame generated by the GFP path frame forming means to the GFP (path frame) network, the GFP network can store the GFP path frame in the layer 1 frame which is the first layer frame of the OSI reference model that accommodates the GFP frame and send the layer 1 frame storing this GFP path frame from the output port corresponding to the label of the GFP frame transfer apparatus to the GFP network. As the first layer of this OSI reference model, it is possible to use SONET (Synchronous Optical NETwork), OTN (Optical Transport Network), etc. When SONET is used as the first layer, the GFP path frame transmitting means can store the GFP path frame in the payload of the SONET frame of SONET and send the SONET frame storing this GFP path frame to the GFP network. On the other hand, when OTN is used as the first layer, the GFP path frame transmitting means can store the GFP path frame in OPUk (Optical channel payload unit) which is the payload of the OTN digital wrapper frame and send the digital wrapper frame storing this GFP path frame to the GFP network.

Furthermore, another GFP frame transfer apparatus of the present invention comprises GFP path frame receiving means for storing a label corresponding to a path ID defined to uniquely specify the path from the Ingress node to Egress node within the GFP network made up of a plurality of GFP nodes in a predetermined field of the extension header area of the GFP frame and receiving the GFP path frame that stores the packet to be transferred through the path in its payload field from the GFP network, label switching means for identifying the output port of the GFP frame transfer apparatus corresponding to the label stored in the extension header area of the GFP path frame and switching the GFP path frame to the identified output port so that the GFP path frame is sent to the GFP network through the transmission path connected to the identified output port and GFP path frame transmitting means for transmitting the GFP path frame switched by the label switching means from the identified output port to the GFP network. This allows each relay node to precisely transfer a GFP path frame using the label and makes it possible to produce in the same way the effect related to transfers of GFP path frames of the effects of the above-described GFP frame transfer apparatus.

Furthermore, it is also possible for each GFP frame transfer apparatus to rewrite the label corresponding to the path ID stored in the extension header area of the GFP path frame according to predetermined rules. In this case, it is possible to obtain the effects of the above GFP frame transfer apparatus using the label swapping system. In this case, the number of necessary labels is smaller than the global label system and when a label area with the same number of bits is used, the number of paths that can be identified and used can be increased compared to the case with the global label system and can accommodate more subscribers.

Furthermore, each GFP frame transfer method of the present invention can also obtain an effect similar to the effect of each GFP frame transfer apparatus of the present invention described above.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A GFP (Generic Frame Procedure) frame transfer apparatus for transferring a GFP frame, comprising a GFP path frame formation section that stores a label corresponding to a path ID defined to uniquely specify the path from the Ingress node to Egress node within a GFP network made up of a plurality of GFP nodes in a predetermined field of the extension header area of said GFP frame, stores packets to be transferred through said path in the payload field of said GFP frame and forms a GFP path frame.

2. The GFP frame transfer apparatus according to claim 1, wherein the length of said extension header area in said GFP path frame is 16 bits.

3. The GFP frame transfer apparatus according to claim 1, wherein said extension header area comprises a label field to store said label, a DE (Discard Eligibility) field to store a flag to indicate priority of discarding said GFP path frame and a reserved field for reservation.

4. The GFP frame transfer apparatus according to claim 3, wherein the size of said label field is 11 bits, the size of said DE field is 1 bit and the size of said reserved field is 4 bits.

5. The GFP frame transfer apparatus according to claim 1, further comprising a packet extraction section that terminates a frame of the subnetwork that stores a packet to be stored in said payload field of said GFP path frame and extracts said packet from the frame of said subnetwork.

6. The GFP frame transfer apparatus according to claim 5, wherein said packet extraction section extracts said packet by removing unnecessary overhead for said subnetwork from the frame of said subnetwork.

7. The GFP frame transfer apparatus according to claim 5, wherein said GFP path frame formation section specifies said label corresponding to said path ID on said GFP network based on routing information stored in said packet.

8. The GFP frame transfer apparatus according to claim 5, wherein said GFP path frame formation section specifies said label corresponding to said path ID on said GFP network based on routing information stored in said packet and the input port when said packet is input to said GFP frame transfer apparatus.

9. The GFP frame transfer apparatus according to claim 7, wherein said packet is an Ethernet MAC frame and said routing information is a DA (Destination Address) stored in said Ethernet MAC frame.

10. The GFP frame transfer apparatus according to claim 7, wherein said packet is an IP packet and said routing information is a DA (Destination Address) stored in said IP packet.

11. The GFP frame transfer apparatus according to claim 1, further comprising a GFP path frame transmission section that stores said GFP path frame formed by said GFP path frame formation section in the layer 1 frame which is the first layer frame of the OSI reference model that accommodates said GFP frame in said GFP network and sends said layer 1 frame storing said GFP path frame from the output port corresponding to said label of said GFP frame transfer apparatus to said GFP network.

12. The GFP frame transfer apparatus according to claim 1, further comprising a label switching section that identifies, when said GFP frame transfer apparatus receives said GFP path frame from said GFP network, the output port of said GFP frame transfer apparatus corresponding to said label stored in said extension header area of said GFP path frame and switches said GFP path frame to said identified output port so that said GFP path frame is sent to said GFP network through the transmission path connected to said identified output port.

13. The GFP frame transfer apparatus according to claim 5, wherein said subnetwork is Ethernet.

14. The GFP frame transfer apparatus according to claim 13, wherein said packet extraction section extracts said packet from the payload of the Ethernet frame of said Ethernet.

15. The GFP frame transfer apparatus according to claim 5, wherein said subnetwork is a POS (Packet Over SONET).

16. The GFP frame transfer apparatus according to claim 15, wherein said packet extraction section extracts said packet from the payload of the HDLC frame of said POS.

17. A GFP (Generic Frame Procedure) frame transfer apparatus for transferring a GFP frame, comprising:
a GFP path frame reception section that stores a label corresponding to a path ID defined to uniquely specify the path from the Ingress node to Egress node within a GFP network made up of a plurality of GFP nodes in a predetermined field of the extension header area and receives the GFP path frame that stores the packet to be transferred through said path in the payload field from said GFP network;
a label switching section that identifies the output port of said GFP frame transfer apparatus corresponding to said label stored in said extension header area of said GFP path frame and switches said GFP path frame to said identified output port so that said GFP path frame is sent to said GFP network through the transmission path connected to said identified output port; and
a GFP path frame transmission section that transmits said GFP path frame switched by said label switching section from said identified output port to said GFP network.

18. The GFP frame transfer apparatus according to claim 17, wherein the length of said extension header area in said GFP path frame is 16 bits.

19. The GFP frame transfer apparatus according to claim 17, wherein said extension header area comprises a label field to store said label, a DE (Discard Eligibility) field to store a flag to indicate priority of discarding said GFP path frame and a reserved field for reservation.

20. The GFP frame transfer apparatus according to claim 19 wherein the size of said label field is 11 bits, the size of said DE field is 1 bit and the size of said reserved field is 4 bits.

21. The GFP frame transfer apparatus according to claim 17, the GFP path frame transmission section stores said GFP path frame in a layer 1 frame which is the first layer frame of an OSI reference model accommodating said GFP path frame in said GFP network and sends said layer 1 frame storing said GFP path frame to said GFP network.

22. The GFP frame transfer apparatus according to claim 11, wherein a SONET (Synchronous Optical NETwork) is used as the first layer of said OSI reference model.

23. The GFP frame transfer apparatus according to claim 22, wherein said GFP path frame transmission section stores said GFP path frame in the payload of the SONET frame of said SONET and sends said SONET frame storing said GFP path frame to said GFP network.

24. The GFP frame transfer apparatus according to claim 11, wherein an OTN (Optical Transport Network) is used as the first layer of said OSI reference model.

25. The GFP frame transfer apparatus according to claim 24, wherein said GFP path frame transmission section stores said GFP path frame in an OPUk (Optical channel payload unit) which is the payload of the digital wrapper frame of said OTN and sends said digital wrapper frame that stores said GFP path frame to said GFP network.

26. The GFP frame transfer apparatus according to claim 12, wherein said label switching section rewrites said label corresponding to said path ID stored in said extension header area according to a predetermined rule.

27. A GFP (Generic Frame Procedure) frame transfer method for transferring a GFP frame, comprising a GFP path frame forming step of storing a label corresponding to a path ID defined to uniquely specify the path from the Ingress node to Egress node within a GFP network made up of a plurality of GFP nodes in a predetermined field of the extension header area of said GFP frame, storing packets to be transferred through said path in the payload field of the said GFP frame and forming a GFP path frame.

28. The GFP frame transfer method according to claim 27, wherein the length of said extension header area in said GFP path frame is 16 bits.

29. The GFP frame transfer method according to claim 27, wherein said extension header area comprises a label field to store said label, a DE (Discard Eligibility) field to store a flag to indicate priority of discarding said GFP path frame and a reserved field for reservation.

30. The GFP frame transfer method according to claim 29, wherein the size of said label field is 11 bits, the size of said DE field is 1 bit and the size of said reserved field is 4 bits.

31. The GFP frame transfer method according to claim 27, further comprising a packet extracting step of terminating a frame of the subnetwork that stores a packet to be stored in said payload field of said GFP path frame and extracting said packet from the frame of said subnetwork.

32. The GFP frame transfer method according to claim 31, wherein in said packet extracting step said packet is extracted by removing unnecessary overhead for said subnetwork from the frame of said subnetwork.

33. The GFP frame transfer method according to claim 31, wherein in said GFP path frame forming step said label corresponding to said path ID on said GFP network is specified based on routing information stored in said packet.

34. The GFP frame transfer method according to claim 31, wherein in said GFP path frame forming step said label corresponding to said path ID on said GFP network is specified based on routing information stored in said packet and the input port when said packet is input to said GFP frame transfer apparatus.

35. The GFP frame transfer method according to claim 33, wherein said packet is an Ethernet MAC frame and said routing information is a DA (Destination Address) stored in said Ethernet MAC frame.

36. The GFP frame transfer method according to claim 33, wherein said packet is an IP packet and said routing information is a DA (Destination Address) stored in said IP packet.

37. The GFP frame transfer method according to claim 27, further comprising a GFP path frame transmitting step of storing said GFP path frame formed in said GFP path frame forming step in the layer 1 frame which is the first layer frame of the OSI reference model that accommodates said GFP frame on said GFP network and sending said layer 1 frame storing said GFP path frame from the output port corresponding to said label of said GFP frame transfer apparatus to said GFP network.

38. The GFP frame transfer method according to claim 27, further comprising a label switching step of identifying, when said GFP frame transfer apparatus receives said GFP path frame from said GFP network, the output port of said GFP frame transfer apparatus corresponding to said label stored in said extension header area of said GFP path frame and switching said GFP path frame to said identified output port so that said GFP path frame is sent to said GFP network through the transmission path connected to said identified output port.

39. The GFP frame transfer method according to claim 31, wherein said subnetwork is Ethernet.

40. The GFP frame transfer method according to claim 39, wherein in said packet extracting step said packet is extracted from the payload of the Ethernet frame of said Ethernet.

41. The GFP frame transfer method according to claim 31, wherein said subnetwork is a POS (Packet Over SONET).

42. The GFP frame transfer method according to claim 41, wherein in said packet extracting step said packet is extracted from the payload of the HDLC frame of said POS.

43. A GFP (Generic Frame Procedure) frame transfer method for transferring a GFP frame, comprising:
a GFP path frame receiving step of storing a label corresponding to a path ID defined to uniquely specify the path from the Ingress node to Egress node within a GFP network made up of a plurality of GFP nodes in a predetermined field of the extension header area and receiving the GFP path frame that stores the packet to be transferred through said path in the payload field from said GFP network;
a label switching step of identifying the output port corresponding to said label stored in said extension header area of said GFP path frame and switching said GFP path frame to said identified output port so that said GFP path frame is sent to said GFP network through the transmission path connected to said identified output port; and
a GFP path frame transmitting step of transmitting said GFP path frame switched in said label switching step from said identified output port to said GFP network.

44. The GFP frame transfer method according to claim 43, wherein the length of said extension header area in said GFP path frame is 16 bits.

45. The GFP frame transfer method according to claim 43, wherein said extension header area comprises a label field to store said label, a DE (Discard Eligibility) field to store a flag to indicate priority of discarding said GFP path frame and a reserved field for reservation.

46. The GFP frame transfer method according to claim 45, wherein the size of said label field is 11 bits, the size of said DE field is 1 bit and the size of said reserved field is 4 bits.

47. The GFP frame transfer method according to claim 43, wherein in said GFP path frame transmitting step, said GFP path frame is stored in the layer 1 frame which is the first layer frame of the OSI reference model that accommodates said GFP frame on said GFP network and said layer 1 frame storing said GFP path frame is sent to said GFP network.

48. The GFP frame transfer method according to claim 37, wherein a SONET (Synchronous Optical NETwork) is used as the first layer of said OSI reference model.

49. The GFP frame transfer method according to claim 48, wherein in said GFP path frame transmitting step, said GFP path frame is stored in the payload of the SONET frame of said SONET and said SONET frame storing said GFP path frame is sent to said GFP network.

50. The GFP frame transfer method according to claim 37, wherein an OTN (Optical Transport Network) is used as the first layer of said OSI reference model.

51. The GFP frame transfer method according to claim 50, wherein in said GFP path frame transmitting step, said GFP path frame is stored in an OPUk (Optical channel payload unit) which is the payload of the digital wrapper frame of said OTN and said digital wrapper frame that stores said GFP path frame is sent to said GFP network.

52. The GFP frame transfer method according to claim 38, wherein in said label switching step, said label corresponding to said path ID stored in said extension header area is rewritten according to a predetermined rule.
